(19) United States
(12) Patent Application Publication
(10) Pub. No.: US 2007/0016253 A1
(43) Pub. Date: Jan. 18, 2007

(54) Primary dental teether

(76) Inventors: Amanda Doherty, Fiskdale, MA (US); Michele Everett, West Brookfield, MA (US); Olga Restrepo, Sturbridge, MA (US)

Correspondence Address: Paul J. Cook, 115 Pine Street, Manchester, MA, 01944, US

(21) Appl. No.: 11/487,757

(22) Filed: Jul. 17, 2006

Related U.S. Application Data
(63) Continuation-in-part of application No. 11/182,186, filed on Jul. 15, 2005.

(51) Int. Cl. A61J 17/00

(52) U.S. Cl. 606/235

(57) ABSTRACT

A teether is provided for a baby which includes a physiologically acceptable preformed polymeric composition which is preformed to the shape of the teeth and gums of a teething baby. The teether retains its preformed shape after use by the baby.

### REFERENCE TO RELATED APPLICATON

This application is a continuation-in-part of co-pending application Ser. No. 11/182,186, filed Jul. 15, 2005.

### BACKGROUND OF THE INVENTION

This invention relates to a teether for a baby. More particularly, this invention relates to a teether for a baby which is preformed to the shape of the first teeth and gums of the baby prior to use.

Teethers are useful during painful teething in order to alleviate pain in the gums of the teething baby. The repetitive biting of the baby is relaxing to the baby. Conventional teethers do not conform to the individual teeth and gum structure of the baby. Thus, the teether does not significantly penetrate spaces between adjacent spaced apart teeth and this portion of the baby's gums does not experience the soothing experience of the remaining portion of the gums which contacts the teether under the force caused by the baby's chewing action.

Accordingly, it would be desirable to provide a baby teether capable of having a preformed shape in the shape of the primary teeth and gums of a teething baby, to effect a soothing experience to the surfaces of the gums including the portion of the gums adjacent spaced apart teeth. Such a teether would provide a more complete soothing experience for the teething baby.

### SUMMARY OF THE INVENTION

In accordance with this invention, a baby teether is provided that is preformed to conform to the shape of the gums and teeth of a teething baby. A teething baby has ten primary teeth on the mandibular (lower) jaw arch and ten primary teeth on the maxillary (upper) jaw arch when all the primary teeth have erupted. Thus, the preformed teether of this invention is preformed to be shaped of all the primary teeth on the mandibular jaw arch and/or on the maxillary jaw arch. The teether includes an arc shaped portion that is anatomically correct for fitting into the baby's mouth and about incoming primary teeth. A handle on the teether is connected to the arch shaped portion and extends outwardly between the baby's lips to prevent the teether from being swallowed during use. The teether is formed of physiologically acceptable materials so as to not cause harm to the baby. The arc shaped portion is shaped to fit on the mandibular jaw arch or the maxillary jaw arch. Alternatively, the teether is formed of two arch shaped portions which fit on both the mandibular and maxillary jaw arches.

The arc or arcs of the teether are preformed to have the indentations shaped to all of the primary teeth of one or both of the jaw arches of the baby for the primary teeth through the eruption of the primary molars. Thus, the shape of the arcs of the teeth are formed to the actual shape of all ten of the baby's primary teeth of the mandibular jaw arch and/or on the maxillary jaw arch.

In one embodiment, two teethers are provided, each having the structure described above but having two different sizes. A first teether has a universal size and shape to accommodate the mandibular jaw arch and the shape of a baby's primary teeth. A second teether has a universal size and shape to accommodate the maxillary jaw arch and the shape of a baby's primary teeth. These teethers can be used sequentially or together depending upon which teeth of the baby are erupting.

### BRIEF DESCRIPTION OF THE DRAWINGS

FIG. 1 is a top view of a teether of this invention which accommodates both jaw arches.

FIG. 2 is a top view of a teether of this invention which accommodates the mandibular jaw arch.

FIG. 3 is a top view of a teether of this invention which accommodates the maxillary jaw arch.

### DETAILED DESCRIPTION OF SPECIFIC EMBODIMENTS

The teethers of this invention are formed of a preformed physiologically acceptable preformed polymeric composition which is sufficiently resilient to fit about the teeth and gums of a teething baby while retaining its shape even when the chewing force of the baby is halted. While the exact shape of primary teeth will vary from baby to baby, the preformed shape of teeth and gums for the teether of this invention can be effected since the general shape and size of primary teeth of teething babies is essentially the same. In addition, since the teethers of this invention are formed of a resilient polymeric composition, the teether will generally conform to the primary teeth and gums during chewing by the teething baby. The teethers of this invention can be formed of polysiloxane (silicone rubber), polyvinylacetate, polyalkylphthalates of the like. The polymeric composition is preformed to the size and shape of the ten primary teeth on each jaw arch of a teething baby; that is on the mandibular jaw arch and/or the maxillary jaw arch. The teether of this invention can be made by conventional injection molding wherein the mold has the size and shape of the desired jaw arch or arches with the ten primary teeth in each arch. The polymeric composition has sufficient resiliency such that it conforms to the teeth and gums of the baby during chewing including the spaces between adjacent spaced-apart teeth which are emerging from the gums and that it retains its preformed shape even when the baby is not chewing the teether. The preformed teether of this invention has at least one arc shaped section sized and shaped to accommodate one or both jaw arches of the baby. The polymeric composition utilized in the present invention has a Shore A hardness between about 20 and about 70, preferably between about 30 and about 60 and most preferably between about 35 and about 50.

A handle extends from an arc shaped section of the teether outwardly from the mouth of the baby. The handle and arc shaped section are formed integrally as one piece from the polymeric composition. In a preferred embodiment, the handle is larger than the width of the baby's mouth to assure that the teether does not enter the baby's throat.

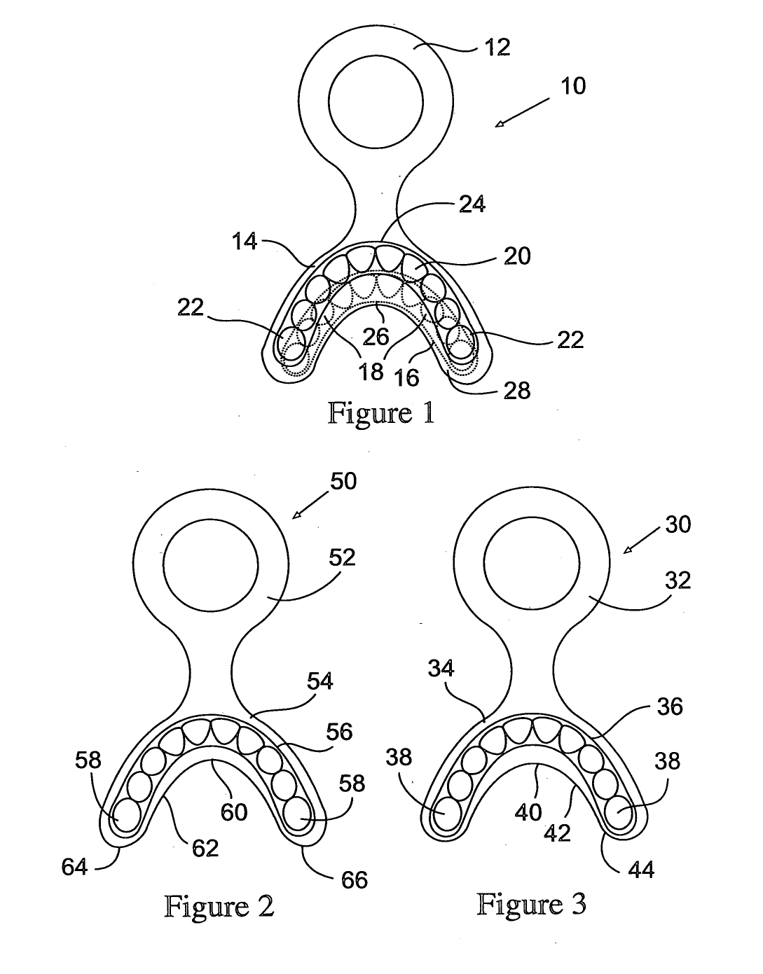

In most children, the first teeth eruption comprises the two front teeth on the lower jaw arch followed by the two teeth adjacent these front teeth on the lower jaw arch. The two front teeth on the upper jaw arch then erupt. Since the upper jaw arch has a slightly different size and shape than the lower jaw arch, it is desirable to replace the teether sized for the lower jaw arch with a teether sized for the upper jaw arch. In this embodiment, two teethers are provided, one preformed to be sized for the upper jaw arch and one preformed to be sized for the lower jar arch. Alternatively, a teether is provided which is preformed to accommodate both the upper jaw arch and the lower jaw arch together. In this embodiment, the two teether arc portions are joined together at an inner portion of the mouth of the body adjacent the most inner molar teeth as shown in FIG. 1.

Referring to the FIG. 1, the teether 10 is formed of a physiologically acceptable preformed polymeric composition. The teether 10 includes a handle 12 and an arc shaped section 14. The arc shaped section 14 is preformed to be sized to fit over the gums and primary teeth of both the mandibular jaw arch and the maxillary jaw arch of a teething baby. As shown in FIG. 1, the arc shaped section 14 is preformed to the shape of both the mandibular arch 16 and teeth 18 as well as the maxillary arch 20 and teeth 22. The teether maintains its preformed shape after use by the teething baby. A typical dimension between the most forward portion 24 of the teether on the maxillary arch 20 to the most forward point 26 of the inner edge 28 of the arc shaped section 14 on the maxillary arch is between about 1.25 and about 2.0 inches to conform to both the mandibular and maxillary jaw arches.

In use, the preformed polymeric composition is shaped with teeth indentations to the shape of the jaw arches and 10 primary teeth of the baby on each jaw arch and, as a result, is preformed to the shape of the baby's emerging teeth and gums, including the space between adjacent spaced apart teeth. As a result, substantially all of the baby's exposed gums are soothed by the compression force on the gums by the resilient polymeric composition exerted by the baby's chewing motion.

Referring to FIG. 2, the teether 30 is formed of a physiologically acceptable preformed polymeric composition. The teether 30 includes a handle 32 and an arc shaped section 34. The arc shaped section 34 is preformed to be sized to fit over the gums and teeth of the mandibular jaw arch. As shown in FIG. 2, after use, the arc shaped section 34 retains its preformed in the shape of the mandibular arch 36 and teeth 38. A typical dimension between the most forward point 40 of the inner edge 42 to one of the least forward points 44 is between about 1.25 and about 1.50 inches to mandibular jaw arch.

Referring to the FIG. 3, the teether 50 is formed of a physiologically acceptable preformed polymeric composition. The teether 50 includes a handle 52 and an arc shaped section 54. The arc shaped section 54 is sized to fit over the gums and teeth of the maxillary jaw arch. As shown in FIG. 3, after use, the arc shaped section 54 retains the shape of the maxillary arch 56 and teeth 58. A typical dimension between the most forward point 60 of the inner edge 62 to each of the least forward points 64 or 66 is between about 1.25 and about 2.0 inches to the maxillary jaw arch.

1. A teether for a teething baby formed of a physiologically acceptable polymeric composition which comprises:
a first arc shaped portion having a size and shape to fit about primary teeth and a mandibular jaw arch and teeth of a teething baby,
a second arc shaped portion having a size and shape to fit about primary teeth and a maxillary jaw arch of a teething baby,
said first arc shaped portion and said second arc shaped portion being connected to each other,
said preformed physiologically acceptable polymeric composition having a shape of the primary teeth and gums of the teething baby during use while retaining the shape of the primary teeth and gums of the teething baby after use,
and a handle formed integrally with one of said arc shaped portions and formed of a physiologically acceptable polymeric composition.

2. A teether for a teething baby formed of a preformed physiologically acceptable polymeric composition which comprises:
an arc shaped portion having a size and shape to fit about primary teeth and a maxillary jaw arch of a teething baby,
said preformed preformed physiologically acceptable polymeric composition having a shape of the primary teeth and gums of the maxillary jaw arch of the teething baby during use while retaining the shape of the maxillary jaw arch and primary teeth of the teething baby after use,
and a handle formed integrally with said arc shaped portion and formed of a physiologically acceptable polymeric composition.

3. A teether for a teething baby formed of a preformed physiologically acceptable polymeric composition which comprises:
an arc shaped portion having a size and shape to fit about primary teeth and a mandibular jaw arch of a teething baby,
said preformed physiologically acceptable polymeric composition having a shape of the primary teeth and gums of the mandibular jaw arch of the teething baby during use while retaining the shape of the mandibular jaw arch and primary teeth of the teething baby after use,
and a handle formed integrally with said arc shaped portion and formed of a physiologically acceptable polymeric composition.

4. The teether of claim 1 wherein the composition is a polysiloxane composition.

5. The teether of claim 2 wherein the composition is a polysiloxane composition.

6. The teether of claim 3 wherein the composition is a polysiloxane composition.
